(19) United States
(12) Patent Application Publication
(10) Pub. No.: US 2010/0302789 A1
(43) Pub. Date: Dec. 2, 2010

(54) LED Light Source Module and Method for Producing the Same

(76) Inventors: Qing LI, Blacksburg, VA (US); Binhai Yu, Foshan (CN); Junzheng Li, Foshan (CN); Lifang Liang, Foshan (CN); Xunli Xia, Foshan (CN)

Correspondence Address: NEW RIVER VALLEY INTELLECTUAL PROPERTY LAW, P.O. BOX 10944, BLACKSBURG, VA, 24062, US

(21) Appl. No.: 12/473,468

(22) Filed: May 28, 2009

(51) Int. Cl. F21V 29/00; H01J 9/00

(52) U.S. Cl. 362/373; 445/23

(57) ABSTRACT

Provided is an LED light source module, comprising a PCB board with electrically conductive pathways, for example wire lines, and at least one through hole; at least one semiconductor light-emitting device; electronic components forming a driving circuit; a metal housing with a groove; and at least one heat sink; wherein the semiconductor light-emitting device is electrically connected to the PCB board, electronic components are disposed on the PCB board, the PCB board is disposed in the groove of the metal housing, the heat sink is disposed in the through hole and connected to the PCB board, the semiconductor light-emitting device is disposed on the upper surface of the heat sink and the bottom of the heat sink is welded with the metal housing.

### BACKGROUND OF THE INVENTION

1. Field of the Invention

The present invention relates to a light source module and a method for producing the same, and particularly to a light emitting diode (LED) light source module and a method for producing the same.

2. Description of the Related Art

Nowadays, LED light sources are widely used for illumination. Existing typical LED light source modules consist of a power LED 011 combined with a heat sink 0111, a conductive lead 0112, a circuit substrate 012 with a through hole 0121, a radiator 013, and a connecting element 014 for connecting the substrate 012 to the radiator 013. To manufacture such devices, typically the power LED 011 combined with the heat sink 0111 is disposed in the through hole 0121 of the circuit substrate 012, then the conductive lead 0112 is connected to the circuit substrate 012, and the power LED 011 is attached to the radiator 013 for dissipating heat. Such modules feature low cost, however, an independent power LED 011 required in this module has to be fixed with the heat sink 0111 and conductive leads 0112 to ensure good heat dissipation. Thus, the module has poor universality. Moreover, the circuit substrate 012 is connected to the radiator 013 by way of the connecting element 014, which causes complex structure and makes the module unsuitable for mass production.

Other existing LED light source modules consist of an LED 021, and power input/output lines 024/025 welded on a PCB board 022, with a waterproof insulation layer 026 covering the PCB board 022 comprising a circuit layer 0221 and a metal plate 0222, a pair of conductive leads of the LED 021, and the power input/output lines 024/025. Additionally, a thermal plate 023 is connected to a metal plate 0222 of the PCB board 022. Disadvantages, however, with the module are that heat is transferred to the outside of the module by way of two interfaces (between the bottom of the LED 021 and the PCB board 022 and between the PCB board 022 and the thermal plate 023, which makes it difficult for heat dissipation. Further, silica gel 027 is required for attaching an independent LED 021 to the circuit layer 0221 of the PCB board 022 and the PCB board 022 to the thermal plate 023, which affects thermal function of the LED 021. The silica gel 027 has a thermal conductivity of 2-5 W/m.K, which affects heat transfer from the LED to the PCB board 022. The thermal conductivity of the silica gel 027 is only 0.01-0.05 times than that of a metal, so heat from the PCB board 022 cannot be quickly transferred to the thermal plate 023. The PCB board 022 comprises an insulating dielectric layer with a low thermal conductivity and thus only has a thermal conductivity of 2 W/m.K, which is only 0.005 times than that of copper. Therefore, the LED light source module has poor heat dissipation performance and features high production cost and price.

In addition, disadvantages with the conventional method are that the process is complex and manufacture is inconvenient, which makes it unsuitable for mass serial production.

Moreover, there are some problems with the LED light sources produced by the conventional method: complex structure, low light emission efficiency and high production cost, which affect mass serial production of the LED light sources.

### SUMMARY OF THE INVENTION

In view of the above-described problems, it is an objective of embodiments of the invention to provide an LED light source that features simple structure, high light emission efficiency, and low production cost, and thus is suitable for mass serial production.

It is another objective of embodiments of the invention to provide a method for producing an LED light source that is simple and provides for convenient manufacture, and thus is suitable for mass serial production.

To achieve the above objectives, in accordance with one aspect of the present invention, there is provided an LED light source module, comprising a PCB board with lines providing electrically conductive pathways, at least one semiconductor light-emitting device, at least one electronic component forming a driving circuit, a metal housing with a groove for receiving and engaging the PCB board, at least one heat sink, and at least one through hole; wherein the semiconductor light-emitting device is electrically connected to the electrically conductive pathways, e.g., electrically conductive lines, of the PCB board, the electronic component is disposed on the PCB board, the PCB board is disposed in the groove of the metal housing, the heat sink is disposed in the through hole of the PCB board and connected to the PCB board, the semiconductor light-emitting device is disposed on the upper surface of the heat sink, and the bottom of the heat sink is welded with the upper surface of the metal housing.

In certain classes of this embodiment, the through hole may be square, rectangular, columnar, truncated or trapezoidal, and the heat sink is joined to the PCB board, including in a riveting manner or by way of interference fit with the through hole.

In certain classes of this embodiment, tin, nickel and silver, or nickel and gold can be plated on the heat sink, and a reflective cup or a step-shaped protrusion is inwardly or outwardly disposed on the upper surface of the heat sink.

In certain classes of this embodiment, a slot and a wire are disposed on both sides of the metal housing, the wire is welded with the electrically conductive pathways, e.g., electrically conductive lines of the PCB board, and a buckle is disposed in the slot of the housing and operates to fix the wire.

In certain classes of this embodiment, the bottom of the metal housing is equipped with cooling fins.

In certain classes of this embodiment, the PCB board is coated with waterproof colloid, and the waterproof colloid covers the electrically conductive lines of the PCB board and the electronic component forming a driving circuit.

In certain classes of this embodiment, the semiconductor light-emitting device is a LED chip, and the LED chip is electrically connected to the electrically conductive pathways, e.g., electrically conductive lines of the PCB board, including by way of metal wires.

In certain classes of this embodiment, the LED chip and the metal wires can be coated with packaging colloid, and/or the packaging colloid operates as an optical lens.

In certain classes of this embodiment, the number of the LED light source modules is one or more.

In accordance with another aspect of the present invention, there is provided a method for producing an LED light source module, comprising: providing a PCB board with electrically conductive pathways, e.g., lines, at least one semiconductor light-emitting device, electronic components forming a driving circuit, and a metal housing with a groove capable of receiving and engaging with the PCB board; producing at least one through hole on the PCB board, producing at least one heat sink capable of engaging with the through hole, disposing the heat sink in the through hole, and applying pressure on the heat sink by way of a mold so as to fixedly attach the heat sink to the PCB board, disposing the semiconductor light-emitting device and electronic components on the upper surface of the heat sink, disposing the PCB board in the groove of the metal housing, and welding the heat sink with the metal housing.

In certain classes of this embodiment, the step of applying pressure on the heat sink by way of a mold so as to fixedly attach the heat sink to the PCB board comprises providing a mold with an upper mold and a lower mold, disposing the PCB board between the upper mold and the lower mold, disposing the heat sink in the through hole of the PCB board, and applying pressure on upper surface and lower surface of the heat sink by way of the mold so that the heat sink is joined to the PCB board in a riveting manner or interference fit with the through hole.

In certain classes of this embodiment, the method further comprises forming a bowl-shaped groove or a step-shaped protrusion on the surface of the heat sink, and performing plating on the surface of the heat sink.

In certain classes of this embodiment, the step of performing plating on the surface of the heat sink comprises plating nickel firstly and then gold or silver on the surface of the heat sink, or plating tin on the surface of the heat sink.

In certain classes of this embodiment, the method further comprises providing a wire and a slot on both sides of the housing, installing a buckle on the wire, welding the wire on the PCB board, and disposing the buckle in the slot so as to fix the wire.

In certain classes of this embodiment, the method further comprises coating the PCB board with waterproof colloid so as to cover the lines of the PCB board and the electronic components forming the driving circuit.

In certain classes of this embodiment, the step of disposing the semiconductor light-emitting device on the upper surface of the heat sink comprises dropping adhesive on the upper surface of the heat sink, attaching the LED chip on the adhesive, connecting electrodes on the LED chip to electrically conductive lines on the PCB board by way of metal wires, and integrally packaging the LED chip on the PCB board by way of a mold so as to form packaging colloid on the LED chip as an optical lens.

In certain classes of this embodiment, the step of integrally packaging the LED chip on the PCB board by way of a mold so as to form packaging colloid on the LED chip as an optical lens comprises providing a mold with an upper mold and a lower mold, the lower mold comprising at least one first cavity, typically a small cavity corresponding to the LED chip, and at least one second cavity, typically a large cavity operating to support the PCB board, and the upper mold comprising at least one plastic injection hole and at least one vent, disposing the PCB board in the large cavity of the lower mold and closing the mold, injecting packaging colloid in the small cavity by way of the plastic injection hole so as to cover the LED chip and the metal wires, curing the packaging colloid in the mold, de-molding and taking out the PCB board; and curing the PCB board in an oven.

In certain classes of this embodiment, the electronic components forming a driving circuit are integrally welded on the PCB board and the heat sink is welded on the upper surface of the metal housing both by way of, for example, a reflow process.

In certain classes of this embodiment, the heat sink capable of engagement with the through hole of the PCB board is made by cutting, extruding, and polishing copper, and a cross sectional area on one side of the heat sink is slightly less than that of the through hole.

Advantages of the Invention Comprise:

1) good heat dissipation effect: since the semiconductor light-emitting device is directly disposed on the heat sink and the heat sink is welded on the metal housing, heat emitted by the semiconductor light-emitting device can be quickly transferred to the housing by way of the heat sink. Therefore, heat conductivity of the invention has a better heat dissipation effect than a traditional metal circuit board.

2) low cost: a combination of the PCB board and the heat sink replaces a traditional and expensive metal circuit board and a ceramic substrate, and thus cost of products is reduced.

3) good generality: directly using the LED chip instead of an LED omits a process of designing a special LED, thus making the invention have better generality and wider application and reducing cost on development and production.

4) simple structure and suitable for mass serial production: since connection between the metal housing and the PCB board is implemented by welding the heat sink in the PCB board with the metal housing and the welding process can be reflow soldering, production efficiency is improved; connection between the heat sink and the PCB board can be implemented by simply pressing the mold and packaging colloid operating as an optical lens is formed by integrally packaging the LED chip on the PCB board by way of a mold, which features high production efficiency and good product uniformity.

### BRIEF DESCRIPTION OF THE DRAWINGS

FIG. 1A is schematic view an LED light source module in the prior art.

FIG. 1B is schematic view of another LED light source module in the prior art.

FIG. 2A is a top view of an inventive LED light source module.

FIG. 2B is a cross-sectional view of an inventive LED light source module.

FIG. 3 is a cross-sectional view of an inventive LED light source module.

FIG. 4A is a cross-sectional view of an inventive LED light source module.

FIG. 4B is a bottom view of an inventive LED light source module.

FIG. 5 is a top view of an inventive LED light source module.

FIG. 6A is a top view of an LED light source module.

FIG. 6B is a schematic diagram of an LED light source module in FIG. 6A.

FIG. 7 is a flowchart of a method for producing an LED light source module.

FIG. 8 is a flowchart illustrating a step S704 of FIG. 7.

FIG. 9 is a flowchart illustrating a step S705 of FIG. 7.

FIG. 10 is a flowchart illustrating a step S7054 of FIG. 9.

### DETAILED DESCRIPTION OF VARIOUS EMBODIMENTS OF THE INVENTION

Reference will now be made in detail to various exemplary embodiments of the invention. The following detailed description is presented for the purpose of describing certain embodiments in detail and is, thus, not to be considered as limiting the invention to the embodiments described. Rather, the true scope of the invention is defined by the claims.

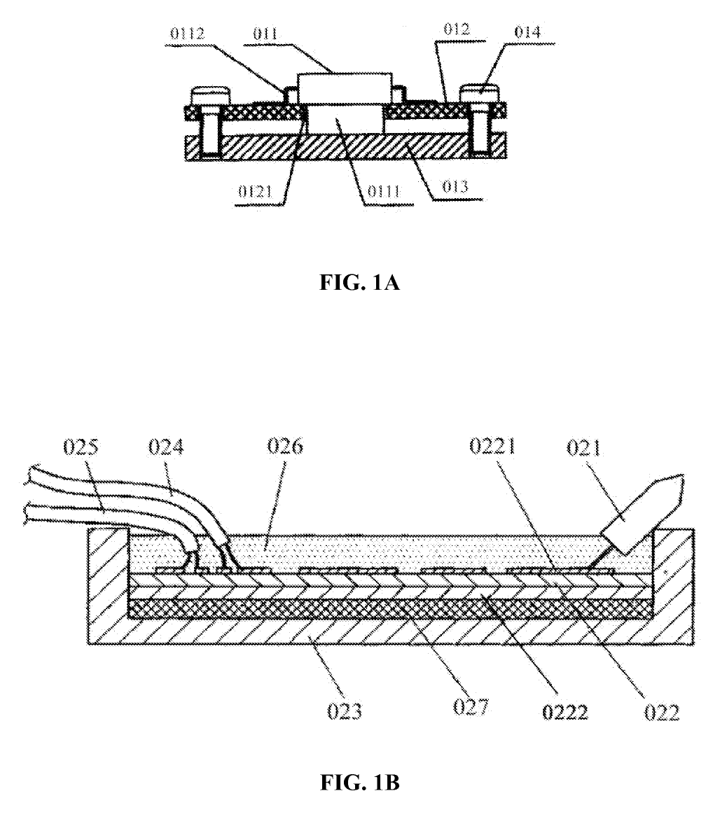

FIG. 1A is a schematic view of an LED light source module in the prior art. FIG. 1A shows an LED light source module comprising a power LED 011 with a heat sink 0111 and a conductive lead 0112, a circuit substrate 012 with a through hole 0121, a radiator 013, and a connecting element 014 for connecting the substrate 012 to the radiator 013. To manufacture such devices, typically the power LED 011 combined with the heat sink 0111 is disposed in the through hole 0121 of the circuit substrate 012, then the conductive lead 0112 is connected to the circuit substrate 012, and the power LED 011 is attached to the radiator 013 for dissipating heat. Such modules feature low cost, however, an independent power LED 011 required in this module has to be fixed with the heat sink 0111 and conductive leads 0112 to ensure good heat dissipation. Thus, the module has poor universality. Moreover, the circuit substrate 012 is connected to the radiator 013 by way of the connecting element 014, which causes complex structure and makes the module unsuitable for mass production.

FIG. 1B is schematic view of another LED light source module in the prior art. FIG. 1B consist of an LED 021, and power input/output lines 024, 025 welded on PCB board 022, with a waterproof insulation layer 026 covering the PCB board 022, a pair of conductive leads of the LED, and the power input/output lines 024, 025. Additionally, a circuit layer 0221 is connected to a metal plate 0222 of the PCB board 022. Disadvantages, however, with the module are that heat is transferred to the outside of the module by way of two interfaces (between the bottom of the LED 021 and the PCB board 022 and between the PCB board 022 and the thermal plate 023), which makes it difficult for heat dissipation. Further, silica gel 027 is required for attaching an independent LED 021 to circuit layer 0221 of the PCB board 022 and the PCB board 022 to the thermal plate 023, which affects thermal function of the LED 021. The silica gel 027 has a thermal conductivity of 2-5 W/m.K, which affects heat transfer from the LED to the PCB board 022. The thermal conductivity of the silica gel 027 is only 0.01-0.05 times than that of a metal, so heat from the PCB board 022 cannot be quickly transferred to the thermal plate 023. The PCB board 022 comprises an insulating dielectric layer with a low thermal conductivity and thus only has a thermal conductivity of 2 W/m.K, which is only 0.005 times than that of copper. Therefore, the LED light source module has poor heat dissipation performance and features high production cost and price.

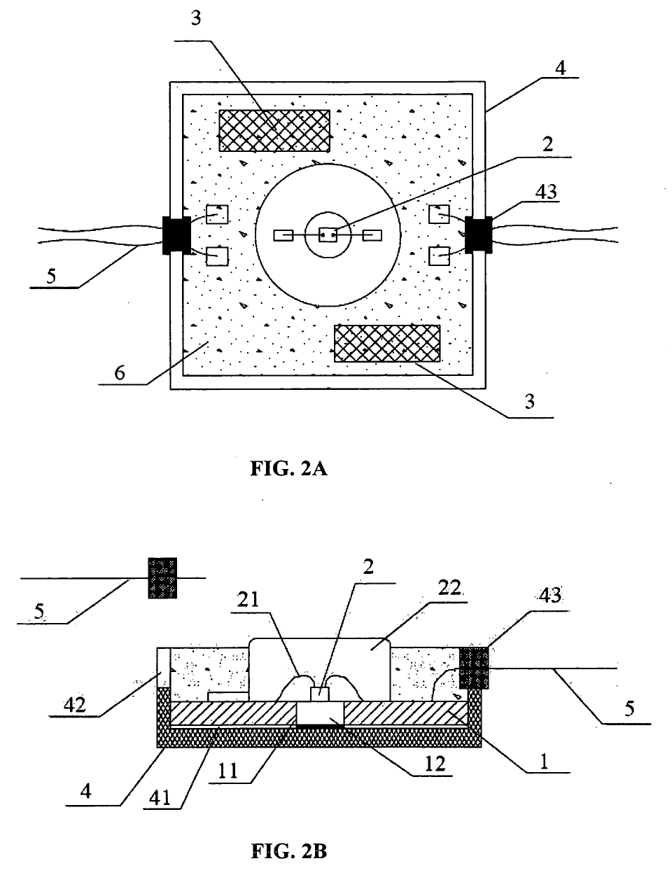

As shown in FIGS. 2A and 2B, an embodiment of an LED light source module of the invention comprises a PCB board 1 with electrically conductive pathways, an LED chip 2 electrically connected to the PCB board 1, an electronic component 3 forming a driving circuit, a metal housing 4 disposed at the bottom of the PCB board 1, and wire 5 welded with the electrically conductive pathway of the PCB board 1. In this embodiment, the PCB board 1 is single-layered or double-layered.

A through hole 11 is disposed on the PCB board 1. In this embodiment, the through hole 11 is columnar and capable of receiving a heat sink 12. A heat sink 12, which is capable of being received by the through hole 11, is disposed in the through hole 11, engaged therewith by way of interference fit with the through hole 11 of the PCB board 1, and connected to the PCB board 1. A reflective cup (not shown) or a step-shaped protrusion (not shown) is inwardly or outwardly disposed on the upper surface of the heat sink 12. In this embodiment, the heat sink is made of copper and plated with nickel and silver. For example, nickel and silver can be plated, optionally sequentially, on the heat sink 12, so as to improve weldability of components and reflection performance. Alternatively, nickel and gold, can be plated on the surface of the heat sink, or only tin can be used.

The LED chip 2 is disposed on the upper surface of the heat sink 12. For example, the LED chip can be disposed on the heat sink 12 by way of adhesives, such as silver paste, then a metal wire 21 electrically connects the LED chip 2 with the PCB board 1. Both the LED chip 2 and the metal wire 21 are optionally covered with packaging colloid 22, so as to implement light distribution and protection.

The metal housing 4 can comprise means for receiving and engaging with the PCB board 1, such as a groove 41 disposed in the metal housing 4. The heat sink 12 is secured to the metal housing with means for encouraging and facilitating the dissipation of heat from the LED module during operation. For example, the bottom of the heat sink 12 optionally can be welded with the metal housing 4. Such a configuration provides for connection and securing of the PCB board 1 with the metal housing 4 due to the heat sink 12 being welded to the metal housing 4 and secured by engagement with through hole 11 in the PCB board 1. In this embodiment, the welding process employs reflow soldering.

Means for securing the wire 5 to the metal housing 4 is optionally provided. For example, a pair of slots 42 can be disposed on opposite sides of the metal housing 4. Such means can be provided by, for example, a buckle 43 which is received in the slot 42 and engaged therewith so as to fix and/or stabilize the wire 5. In this embodiment, the metal housing 4 can be made of aluminum, iron or copper, and preferably copper. The buckle 43 can be made of elastic plastics. As the buckle 43 is inserted in the slot 42, the wire 5is fixed, and the slot 42 is sealed.

The PCB board 1 can be coated with waterproof colloid 6, in such a way as to cover the electrically conductive pathways of the PCB board 1 and the electronic component 3 forming the driving circuit, for protection and/or securing of these electrical components. In this embodiment, the waterproof colloid 6 is polyurethane resin. It should be noted that the waterproof colloid 6 is optional and in other embodiments can be omitted.

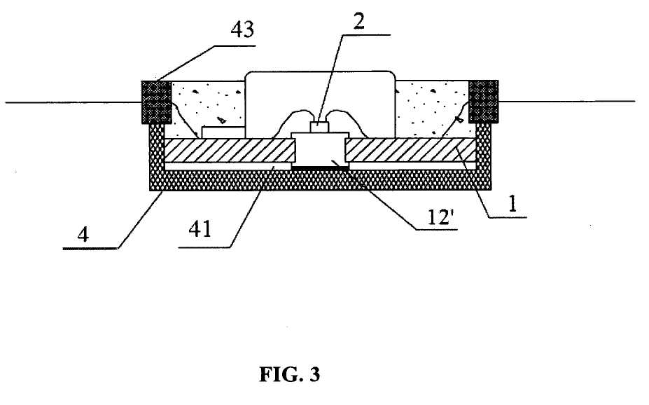

As shown in FIG. 3, the structure of the LED light source module is similar to that in FIG. 2A, with the heat sink 12′ rivet connected the PCB board 1.

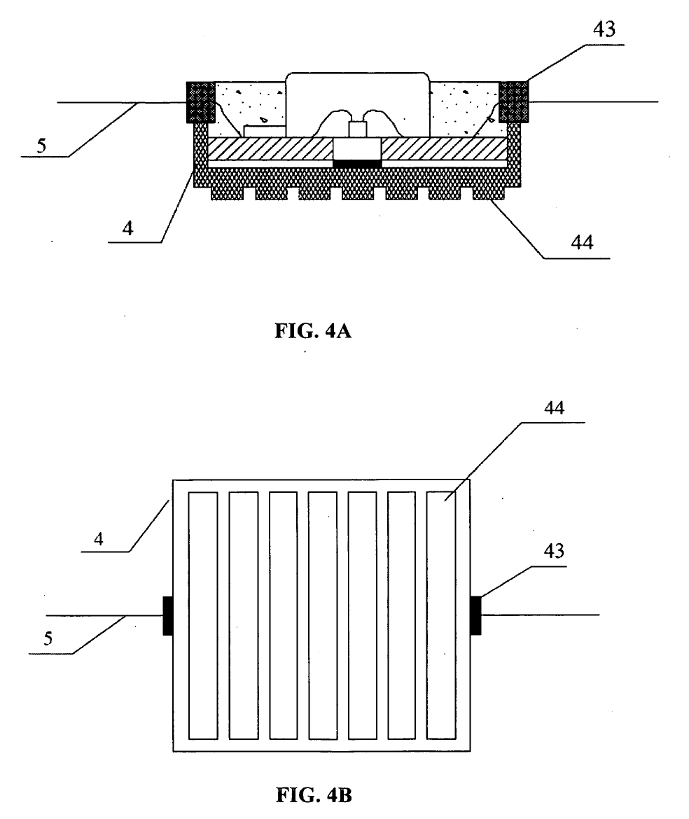

As shown in FIGS. 4A and 4B, the structure of the LED light source module of this embodiment is similar to that in FIG. 2A, with the bottom of the metal housing 4 equipped with cooling fins 44 to increase heat dissipating area of the device and to improve heat dissipating effect during operation of the device.

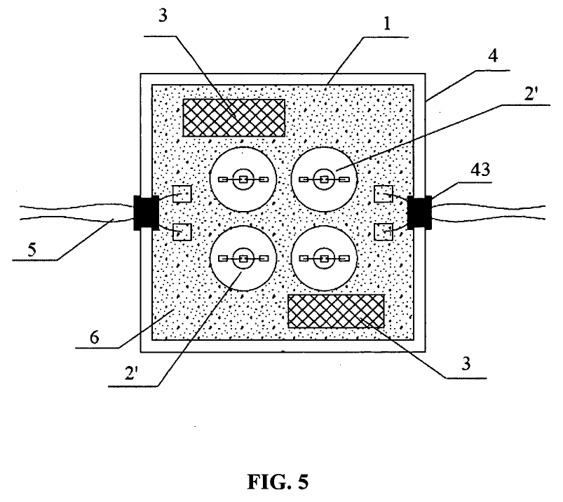

As shown in FIG. 5, the structure of the LED light source module of this embodiment is similar to that in FIG. 2A, with four LED chips 2′. In this embodiment, each LED chip 2′ is disposed on a heat sink 12 and electrically connected to the PCB board 1. More specifically, four through holes (not shown) are disposed on the PCB board 1, the heat sinks (not shown) are disposed in each of the through holes and connected to the PCB board 1, each LED chip 2′ is disposed on the surface of each heat sink, the metal wire (not shown) electrically connects the LED chips 2′ to the PCB board 1, the packaging colloid (not shown) covers and protects the LED chips 2′ and the metal wire. In other embodiments, any number of LED chips 2, 2′ can be used depending on the particular application, for example, LED light source modules according to the invention can comprise two or more LED chips 2, 2′.

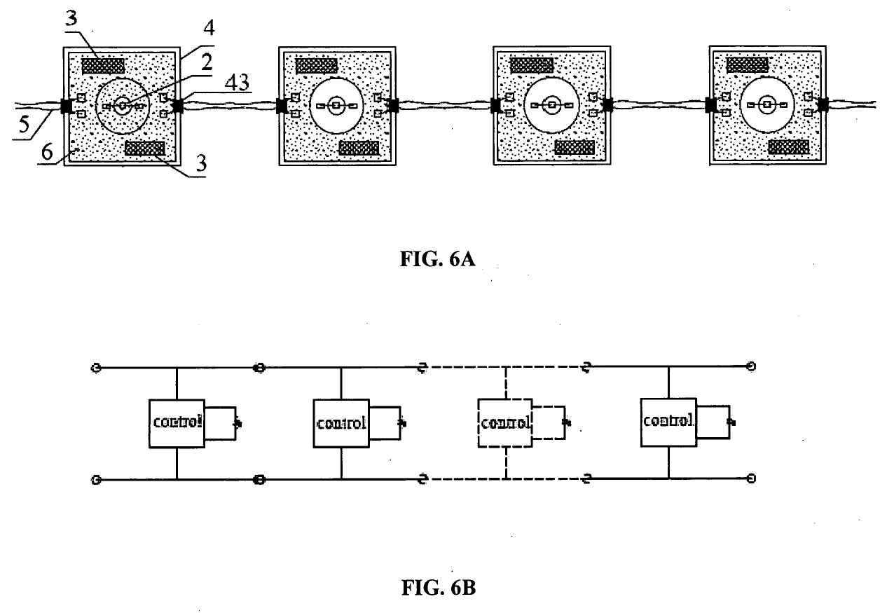

As shown in FIG. 6A, the structure of the LED light source module of this embodiment is similar to that in FIG. 2A, with a plurality of LED light source modules connected together in parallel. In addition, the structure of the LED light source module may be the same as those described in the other embodiments above.

FIG. 6B is a schematic diagram of an LED light source module in FIG. 6A

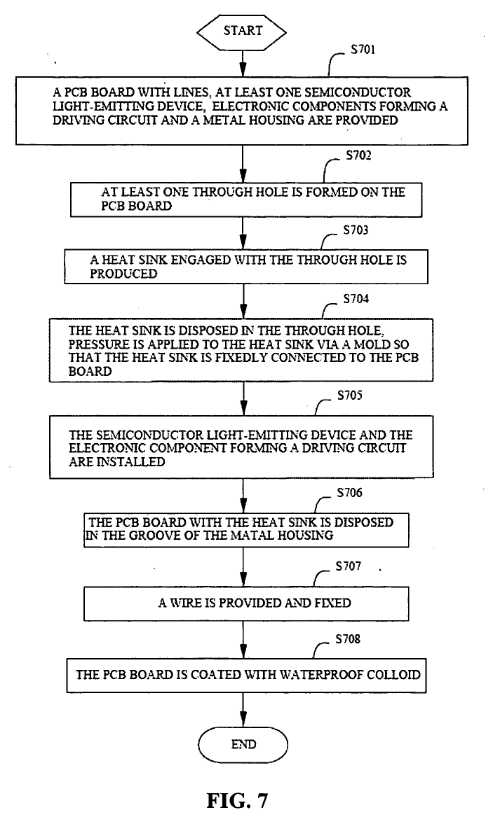

As shown in FIG. 7, in step S701, a PCB board with lines, at least one semiconductor light-emitting device, electronic components forming a driving circuit and a metal housing are provided. In this embodiment, the PCB board is single-layered or double-layered. A groove capable of engaging with the PCB board is disposed in the metal housing.

In step S702, at least one through hole is formed on the PCB board. The through holes in the PCB board may be made by any appropriate means known in the art. For example, in this embodiment, the through hole is formed by punching or drilling. The through hole may be rectangular, square, columnar, truncated or step-shaped, or any shape and size capable of providing engagement means with the heat sink. Typically, the size and shape of the through hole is complementary to the size and shape of the heat sink. In preferred embodiments, the through hole and corresponding heat sink are shaped and sized to provide an interference fit between them when the heat sink is disposed within the through hole.

In step S703, a heat sink is engaged with the through hole of the PCB board. In some embodiments, the cross-sectional area on one side of the heat sink can be slightly less than that of the through hole, which provides for ease of insertion of the heat sink in the through hole. The height of the heat sink can be greater, less than, or equal to the depth of the through hole. In this embodiment, the heat sink is made of heat conductive metal, and preferably comprises copper. The heat sink is made by cutting, extruding and polishing the copper, and may be columnar, truncated or cubic. In this embodiment, the shape and size of the heat sink correspond to those of the through hole on the PCB board. In embodiments, the upper surface and/or a lower surface of the heat sink is step-shaped and a cross sectional area of the upper or lower surface is greater than that of the corresponding through hole.

In step S704, the heat sink is disposed in the through hole and pressure is applied to the heat sink by way of a mold so that the heat sink is fixedly connected to the PCB board.

In step S705, the semiconductor light-emitting device and the electronic components forming a driving circuit are installed. More specifically, the semiconductor light-emitting device is disposed on the upper surface of the heat sink, and the electronic components forming a driving circuit are welded on the PCB board by way of reflow soldering. An LED chip may be preferentially chosen as the semiconductor light-emitting diode.

In step S706, the PCB board with the heat sink is disposed in the groove of the metal housing, and the bottom of the heat sink is welded with the metal housing. In this embodiment, the metal housing is integrally formed, and comprises heat conductive metals like aluminum, iron, copper and so on, and preferably copper. A pair of slots is disposed on both sides of the metal housing, and the bottom of the metal housing is equipped with cooling fins.

In Step S707, electrically conductive wire is provided and fixed. More specifically, metal wire and a buckle made of elastic plastics are provided. The buckle is disposed on the wire and engaged therewith in such a manner as to secure the wire with the buckle, such as with slots in the buckle corresponding in size and shape with the wire and/or with other snap fit type securing means. The wire is welded on the PCB in such a manner as to operably connect the wire with the electrically conductive pathway of the PCB board. The buckle is disposed in the slot of the housing so as to fix the wire and seal the slot. In embodiments, the wire can be welded on the PCB board before the buckle is disposed thereon.

In step S708, the PCB board is coated with waterproof colloid so as to cover the electrically conductive pathways of the PCB board and the electronic component forming a driving circuit in such a manner so as to secure the components together and/or provide protection for them against negative environmental elements, for example. In this embodiment, the waterproof colloid is made of polyurethane resin. In other embodiments, a waterproof colloid may be optionally omitted.

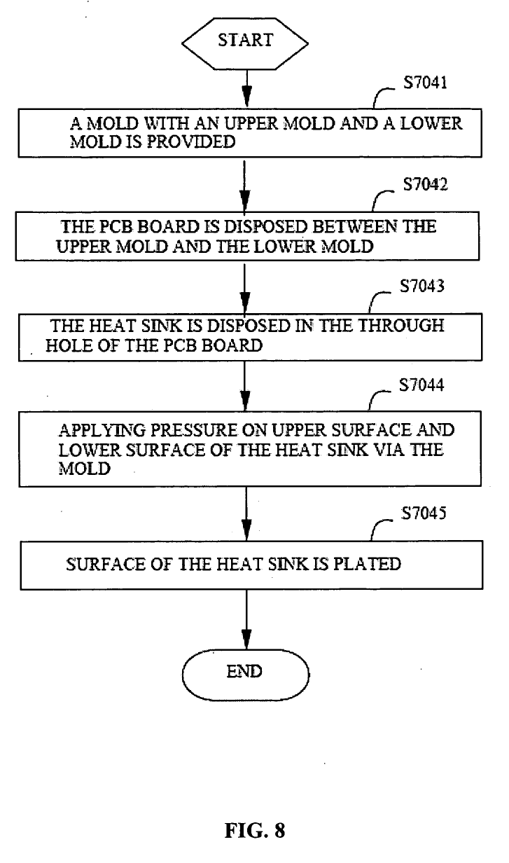

As shown in FIG. 8, in step S7041, a mold with an upper mold and a lower mold is provided. In step S7042, the PCB board is disposed between the upper mold and the lower mold. In step S7043, the heat sink is disposed in the through hole of the PCB board, so that the upper and lower surfaces of the heat sink are higher/lower than or aligned with the upper and lower surfaces of the PCB board. In step S7044, pressure is applied on the upper surface and lower surface of the heat sink by way of the mold so that the heat sink is joined with the PCB board in a rivet manner or interference fit with the through hole. In embodiments, a bowl-shaped groove or a step-shaped protrusion can be formed on the surface of the heat sink as the pressure is applied in the mold. In step S7045, the surface of the heat sink is plated. In this embodiment, nickel first and then silver is plated on the surface of the heat sink. In other embodiments, nickel first and then gold, or only tin is plated thereon, and the plating processing may be performed on the upper and lower surface of the heat sink before the heat sink is installed.

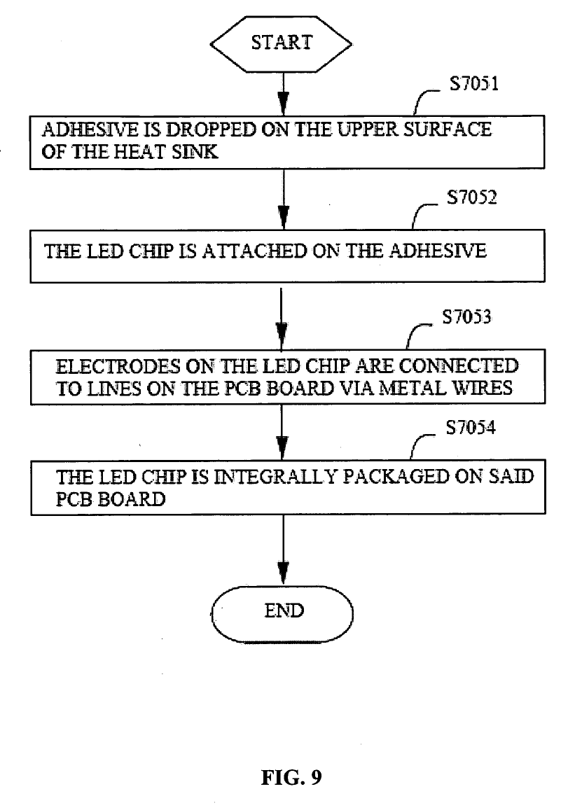

As shown in FIG. 9, in step S7051, adhesive is dropped on the upper surface of the heat sink. In step S7052, the LED chip is attached on the adhesive. In step S7053, electrodes on the LED chip are connected to lines on the PCB board by way of metal wires. In step S7054, the LED chip is integrally packaged on said PCB board by way of a mold so as to form packaging colloid operating as an optical lens.

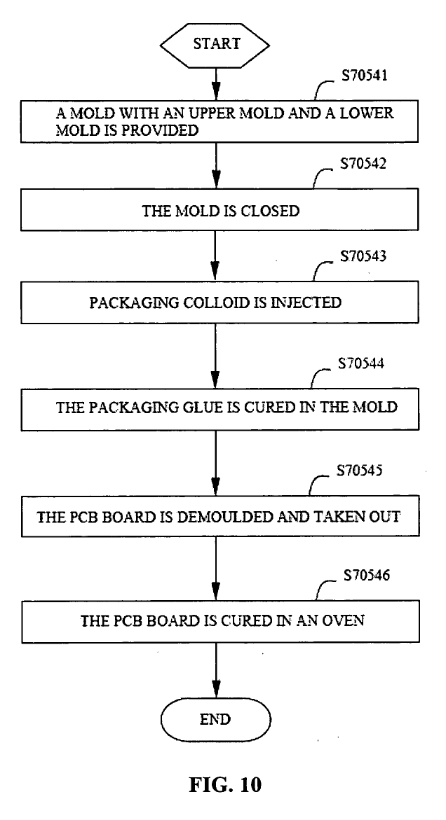

As shown in FIG. 10, in step S7054 1, a mold with an upper mold and a lower mold is provided, wherein the lower mold comprises a first cavity, typically a small cavity corresponding to the LED chip, and a second cavity, typically a large cavity operating to support the PCB board, and wherein the upper mold comprises a plastic injection hole and a vent. In step S70542, the PCB board is disposed in the large cavity of the lower mold and the mold is closed. In step S70543, packaging colloid is injected in the small cavity by way of the plastic injection hole so as to cover the LED chip and the metal wires. In step S70544, the packaging colloid is cured in the mold. In step S70545, the PCB board is de-molded and taken out. In step S70546, the PCB board is cured in an oven.

The inventive LED lighting source module and methods of making them are applicable to a wide variety of applications, including for advertisement, signage, decorative lighting and so on. Furthermore, for example, the LED lighting source module can be configured for various types of lighting sources by designing its shape and/or by comprising an appropriate number and formatting of LED chips. The module can also be adapted to generate any desired color of light such as white light by substituting the LED chip(s) and/or adding fluorescent material(s) accordingly.

The present invention has been described with reference to particular embodiments having various features. It will be apparent to those skilled in the art that various modifications and variations can be made in the practice of the present invention without departing from the scope or spirit of the invention. One skilled in the art will recognize that these features may be used singularly or in any combination based on the requirements and specifications of a given application or design. Other embodiments of the invention will be apparent to those skilled in the art from consideration of the specification and practice of the invention. The description of the invention provided is merely exemplary in nature and, thus, variations that do not depart from the essence of the invention are intended to be within the scope of the invention.

1. An LED light source module comprising:
a metal housing with an upper and lower surface and a groove for receiving a PCB board;
a PCB board with at least one electrically conductive pathway and at least one through hole, wherein the PCB board is disposed on the upper surface of and in the groove of the metal housing;
electronic driving circuit components disposed on and operably connected with the at least one electrically conductive pathway of the PCB board;
at least one heat sink having an upper surface and a lower surface and disposed in and connected with the through hole of the PCB board, wherein the lower surface of the at least one heat sink is welded with the upper surface of the metal housing; and
at least one semiconductor light-emitting device disposed on the upper surface of the heat sink and operably connected to the at least one electrically conductive pathway.

2. The LED light source module of claim 1, wherein the through hole is square, rectangular, columnar, truncated or trapezoidal; and the heat sink is connected to the PCB board in a riveting manner or interference fit with the through hole.

3. The LED light source module of claim 1, wherein
the heat sink has nickel and silver, or nickel and gold, or tin plating; and
the heat sink has a reflective cup or a step-shaped protrusion inwardly or outwardly disposed on the upper surface of the heat sink.

4. The LED light source module of claim 1, wherein
the metal housing has one or more sides with a slot;
wire capable of providing an electrical pathway to and from the at least one electrically conductive pathway of the PCB board during operation is operably connected to the PCB board;
and a buckle disposed in the slot and connected to the wire fixes the wire to the housing.

5. The LED light source module of claim 1, wherein the lower surface of the metal housing comprises cooling fins.

6. The LED light source module of claim 1, wherein
the PCB board is coated with waterproof colloid; and
the waterproof colloid covers the at least one electrically conductive pathway of the PCB board and the electronic driving circuit components.

7. The LED light source module of claim 1, wherein
the semiconductor light-emitting device is an LED chip; and
the LED chip is operably connected to the PCB board with metal wires capable of providing an electrical pathway to and from the LED chip during operation.

8. The LED light source module of claim 7, wherein
the LED chip and the metal wires capable of providing an electrical pathway to and from the LED chip during operation are coated with packaging colloid; and
the packaging colloid is capable of operating as an optical lens.

9. The LED light source module of claim 1 operably connected with a second LED light source module of claim 1.

10. A method for producing an LED light source module, comprising:
providing a PCB board with at least one electrically conductive pathway, at least one semiconductor light-emitting device, electronic driving circuit components, and a metal housing with an upper surface and a grove capable of receiving the PCB board;
producing at least one through hole on the PCB board;
forming at least one heat sink capable of engaging with the through hole;
disposing the heat sink in the through hole, and applying pressure on the heat sink by way of a mold so as to fixedly attach the heat sink to the PCB board;
disposing the semiconductor light-emitting device on an upper surface of the heat sink;
disposing the electronic driving circuit components on the PCB board;
disposing the PCB board in the groove of the metal housing; and
welding the heat sink with the upper surface of the metal housing.

11. The method for producing an LED light source module of claim 10, wherein applying pressure on the heat sink comprises:
providing a mold with an upper mold and a lower mold;
disposing the PCB board between the upper mold and the lower mold;
disposing the heat sink in the through hole of the PCB board; and
applying pressure on the upper surface and a lower surface of the heat sink with the mold such that the heat sink is connected to the PCB board in a riveting manner or interference fit with the through hole.

12. The method for producing an LED light source module of claim 11, further comprising forming a bowl-shaped groove or a step-shaped protrusion on the upper surface of the heat sink and forming a reflective surface on the upper surface of the heat sink.

13. The method for producing an LED light source module of claim 12, wherein forming a reflective surface on the upper surface of the heat sink comprises plating nickel then gold or silver or plating tin on the upper surface of the heat sink.

14. The method for producing an LED light source module of claim 10, further comprising:
providing a wire and a slot on one or more sides of the housing;
installing a buckle on the wire;
welding the wire on the PCB board; and
disposing the buckle in the slot so as to fix the wire.

15. The method for producing an LED light source module of claim 10, further comprising coating the PCB board with waterproof colloid so as to cover the at least one electrically conductive pathway of the PCB board and the electronic driving circuit components.

16. The method for producing an LED light source module of claim 10, wherein disposing the semiconductor light-emitting device on the upper surface of the heat sink comprises:
providing adhesive on the upper surface of the heat sink;
attaching the LED chip to the adhesive;
connecting electrodes on the LED chip and the at least one electrically conductive pathway of the PCB board with metal wires; and
integrally packaging the LED chip and the PCB board using a mold for providing packaging colloid capable of operating as an optical lens.

17. The method for producing an LED light source module of claim 16, wherein integrally packaging comprises:
providing a mold with an upper mold comprising at least one plastic injection hole and at least one vent and a lower mold comprising a first cavity for the LED chip and a second cavity for the PCB board;
disposing the PCB board in the second cavity of the lower mold and closing the mold;
injecting packaging colloid in the first cavity by way of the at least one plastic injection hole such that the packaging colloid covers the LED chip and the metal wires;
curing the packaging colloid in the mold;
removing the PCB board from the mold; and
curing the PCB board in an oven.

18. The method for producing an LED light source module of claim 10, wherein the electronic driving circuit components are integrally welded on the PCB board and the heat sink is welded on the upper surface of the metal housing by way of a reflow process.

19. The method for producing an LED light source module of claim 10, wherein forming the heat sink comprises cutting, extruding and polishing copper and a cross sectional area on one side of the heat sink is smaller than that of the through hole.

20. A lighting source device comprising an LED light source module comprising:
a metal housing with an upper and lower surface and a groove for receiving a PCB board;
a PCB board with at least one electrically conductive pathway and at least one through hole, wherein the PCB board is disposed on the upper surface of and in the groove of the metal housing;
electronic driving circuit components disposed on and operably connected with the at least one electrically conductive pathway of the PCB board;
at least one heat sink having an upper surface and a lower surface and disposed in and connected with the through hole of the PCB board, wherein the lower surface of the at least one heat sink is welded with the upper surface of the metal housing; and
at least one semiconductor light-emitting device disposed on the upper surface of the heat sink and operably connected to the at least one electrically conductive pathway.

21. The lighting source device of claim 20 which is a decorative lighting device.
